(19) United States
(12) Patent Application Publication
(10) Pub. No.: US 2008/0237927 A1
(43) Pub. Date: Oct. 2, 2008

(54) METHOD FOR STRETCHING POLYMER FILM AND DEVICE FOR RECOVERING SLIT FILM EDGE

(75) Inventor: Shinsuke AOSHIMA, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/057,995

(22) Filed: Mar. 28, 2008

(30) Foreign Application Priority Data
Mar. 28, 2007 (JP) 2007-084426

(51) Int. Cl. B29C 55/20

(52) U.S. Cl. 264/289.3; 425/216

(57) ABSTRACT

A rear end portion of a leading TAC film and a front end portion of a following TAC film are connected using a double-sided adhesive tape and a single-sided adhesive tape. Both side edges of the TAC films are slit with cutters of an edge slitting device. The slit side edges are sent to a cutter blower. In the cutter blower, the slit side edges are cut into small pieces and sent to a crusher through a first pipe. Upon receiving a tape detection signal, a plate controller rotates a plate from a close position to an open position. When the plate is in the open position, the cut films are sent from the first pipe to a second pipe via an opening, and then to a receptacle.

### FIELD OF THE INVENTION

The present invention relates to a method for stretching polymer films and a device for recovering edges which have been slit from the films.

### BACKGROUND OF THE INVENTION

In recent years, liquid crystal displays have been rapidly developed and spread. This trend caused an increase in demand for cellulose acylate films, especially triacetyl cellulose (TAC) films that are used as a protective film for the liquid crystal displays. Along with the increase in demand, the productivity of the TAC films is desired to be improved. The TAC films are often produced according to the following method. At first, a dope including TAC and a solvent is cast using a casting die onto a continuously running support to form a casting film. The casting film is dried or cooled to develop its self-supporting properties. After having possessed the self-supporting properties, the casting film is peeled from the support, and then dried and wound as a TAC film. According to such solution casting method, the produced film has few foreign substances mixed therein and has excellent optical properties, as compared to films produced according to a melt extrusion method.

In the solution casting method, the support for the dope may be a belt or a drum. To improve the casting speed, the drum is more preferred as compared to the belt. The casting film on the support is dried, or cooled and gelated in order to develop the self-supporting properties. Meanwhile, the film is stretched in order to control the optical properties, especially the retardation characteristics, of the produced TAC film.

Optimum speed of the film production and that of the film stretching vary from each other. The film production speed, that is, the casting speed is generally slower than the film stretching speed. Therefore, when the stretching speed is adjusted to the casting speed, the film may not be sufficiently stretched to improve the optical properties of the produced TAC film. In view of this, it is proposed that the film is stretched off-line, that is, outside a solution casting line (see, for example, Japanese Patent Laid-open Publication No. 2002-311240).

As disclosed in the Japanese Patent Laid-open Publication No. 2002-311240, when the film is stretched off-line, that is, independently from the solution casting line, it is preferable to stretch the film continuously so as to perform the film stretching effectively. In order to stretch the film continuously, a rear end of a leading film and a front end of a following film may be connected using a connection tape.

During the stretching, both side edges of the film are held with holding members like clips. The film edges held with clips cannot be used as a product, and therefore they are slit to be separated from a main part of the film. The main part is a center part in the width direction of the film between the side edges thereof, and is going to be the end product. It is preferable to shred the slit edges into chips to be recycled for preparing the dope, in view of economic advantages.

However, when the connection tape is used for connecting the TAC films, the connection tape is mixed into the slit film edges. Since the components of the connection tape and the TAC film are different, the connection tape becomes a foreign substance when the slit film edges are used for preparing the dope. The mixture of the connection tape lowers the quality of the recycled TAC film. Such problems are not limited to the TAC film production, but may arise in any polymer film production where the slit film edges are recycled for preparing the dope.

### SUMMARY OF THE INVENTION

It is an object of the present invention to provide a method for stretching polymer films and a device for recovering slit film edges which maintain the quality of recycled polymer films when using the film edges for the recycling.

In order to achieve the above and other objects, a method according to the present invention for stretching polymer films in width directions thereof includes connecting step, supplying step, stretching step, slitting step, cutter-blower step, separating step, and recovering step. In the connecting step, a rear end of leading polymer film and a front end of following polymer film are connected using a connection tape. In the supplying step, the connected polymer films are supplied continuously. In the stretching step, the supplied polymer films are stretched by being held at both side edges thereof with clips. The polymer films are conveyed by the clips during the stretching step. In the slitting step, the side edges are slit from main parts of the polymer films after the stretching step. The main part is a center part in the width direction of the polymer film between the side edges. The main part is going to be an end product. In the cutter-blower step, the slit side edges are cut into small pieces and blown by the cutter blower. In the separating step, the small pieces with the connection tape are separated from other small pieces based on information indicating position of the connection tape. In the recovering step, the small pieces with the connection tape and other small pieces are recovered separately.

It is preferable that the connection tape is positioned besides lines along which the side edges are slit.

A recovering device according to the present invention for recovering slit film edges is provided to a film stretching device. The film stretching device connects a rear end of a leading polymer film and a front end of a following polymer film using a connection tape, supplies the connected polymer films continuously, and stretches the supplied polymer films in width directions thereof by holding both side edges thereof with clips. The polymer films are conveyed by the clips during the stretching step. The recovering device of the present invention includes a slitting device, a cutter blower, a separating member, and a recovering section. The slitting device slits the side edges from main parts of the polymer films after the stretching step. The main part is a center part in the width direction of the polymer film between the side edges. The main part is going to be an end product. The cutter blower cuts the slit side edges into small pieces and blows them. The separating member is provided downstream from the cutter blower and separates the small pieces with the connection tape from other small pieces based on information indicating position of the connection tape. The recovering section recovers the small pieces with the connection tape and other small pieces separately.

According to the present invention, the small pieces with the connection tape are separated from other small pieces based on the information indicating the position of the connection tape. Owing to this, the connection tape is not mixed to the recovered side edges. This prevents deterioration in quality of the recycled polymer films.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a schematic view illustrating an off-line stretching device;

FIG. 2 is a schematic view illustrating a tenter;

FIG. 3 is a side elevational view illustrating a clip;

FIG. 4 is a perspective view illustrating a leading TAC film, a following TAC film, a double-sided adhesive tape, and single-sided adhesive tapes;

FIG. 5 is a top plan view illustrating the leading TAC film, the following TAC film, the double-sided adhesive tape, the single-sided adhesive tapes, and cutters; and

FIG. 6A is a sectional side view illustrating a first pipe and a second pipe in which a plate is in a close position and FIG. 6B is a sectional side view illustrating the same in which the plate is in an open position.

### DESCRIPTION OF THE PREFERRED EMBODIMENTS

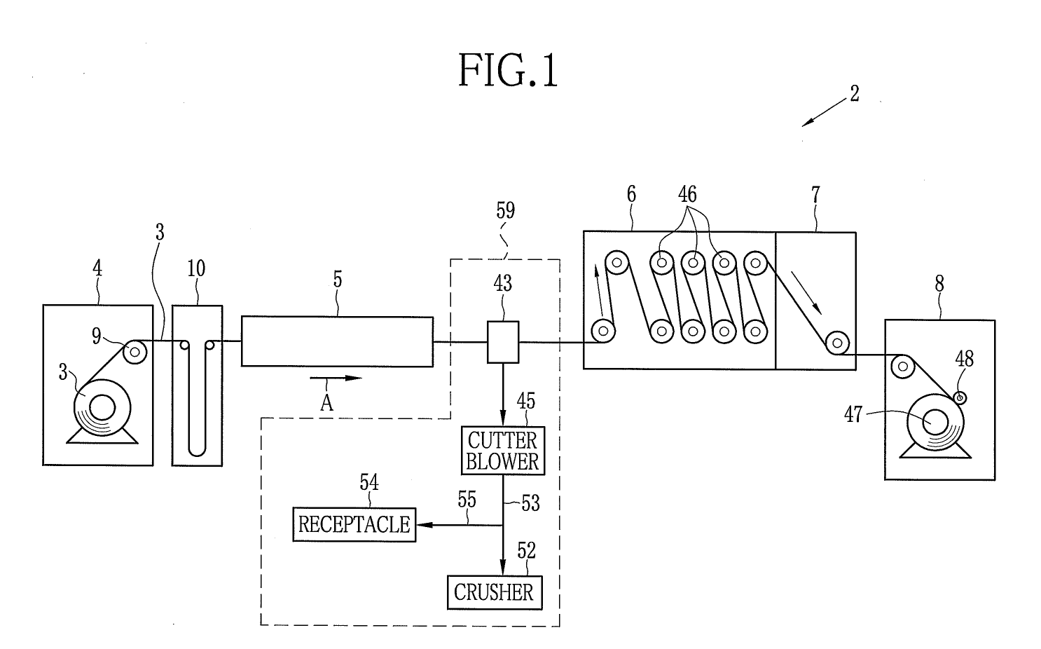

As shown in FIG. 1, an off-line stretching device 2 is for stretching a TAC film 3, and provided with a supplying chamber 4, a tenter 5, a stress relaxation chamber 6 by heating, a cooling chamber 7, and a winding chamber 8. The supplying chamber 4 stores the TAC film 3, which has been produced in a solution casting line, in a roll form. The TAC film 3 is supplied by a supply roller 9 to the tenter 5.

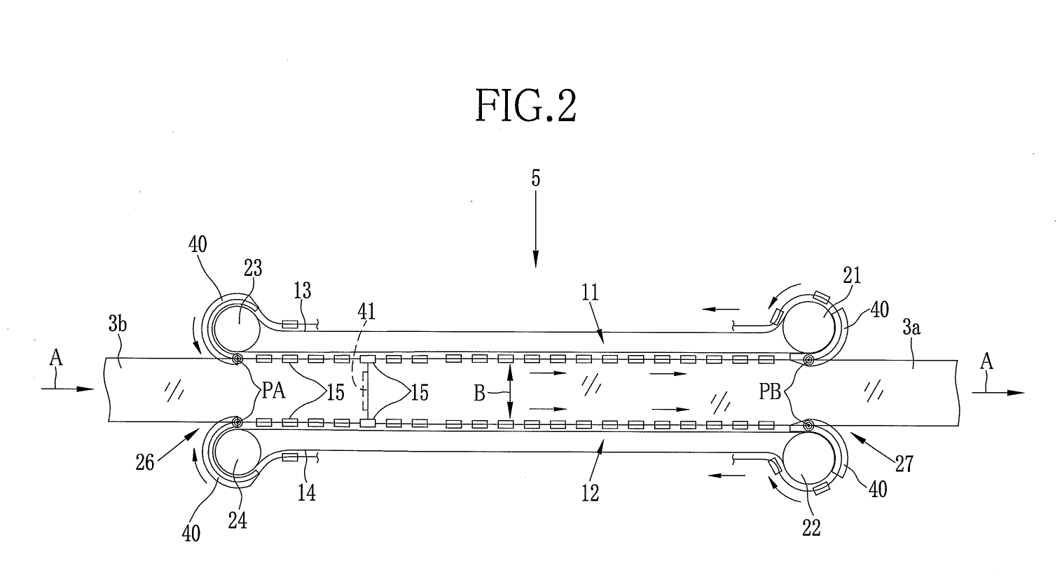

In the tenter 5, both side edges of the TAC film 3 are held with clips 15 (see FIG. 2). While being conveyed at this state, the TAC film 3 is heated and stretched in film width directions B (see FIG. 2). The TAC film 3 is stretched by preferably 100.5% to 300% in the film width directions B with respect to the width of the TAC film 3 before the stretching.

A reservoir 10 is provided between the supplying chamber 4 and the tenter 5. In the reservoir 10, a certain length of TAC film 3 is reserved to form a loop. The certain length is a length enough for connecting the TAC films 3. The film connection is described later. After forming the loop, the TAC film 3 is sent to the tenter 5.

As shown in FIG. 2, the TAC film 3 is conveyed in a convey direction A and stretched in the film width directions B in the tenter 5. The tenter 5 is provided with a first rail 11, a second rail 12, a first chain 13 and a second chain 14 (both are endless chains). The first chain 13 is guided by the first rail 11, and the second chain 14 is guided by the second rail 12. Temperature inside the tenter 5 is kept high. The tenter 5 may be divided into plural zones in the convey direction A as necessary so as to change conditions for heating the TAC film 3 in each zone. For example, the tenter 5 may be divided, from upstream to downstream thereof, into pre-heating zone, heating zone, and stress relaxation zone by heating, in the convey direction A.

The clips 15 are attached to the first and second chains 13 and 14 at certain intervals. While holding the side edges of the TAC film 3, the clips 15 are moved along each rail 11 or 12, and thereby stretching the TAC film 3 in the film width directions B. In this embodiment, the TAC film 3 is stretched in the film width directions B such that the width of the TAC film 3 after the stretching becomes 103% of the width of the same before the stretching. The stretch ratio is not limited to this, but may be appropriately changed in accordance with desired optical properties and the like.

The first chain 13 is bridged across a drive sprocket wheel 21 and a driven sprocket wheel 23, and guided by the first rail 11. The second chain 14 is bridged across a drive sprocket wheel 22 and a driven sprocket wheel 24, and guided by the second rail 12. The drive sprocket wheels 21 and 22 are provided at a tenter exit 27 side, and are driven and rotated by drive mechanisms (not shown). The driven sprocket wheels 23 and 24 are provided at a tenter entrance 26 side.

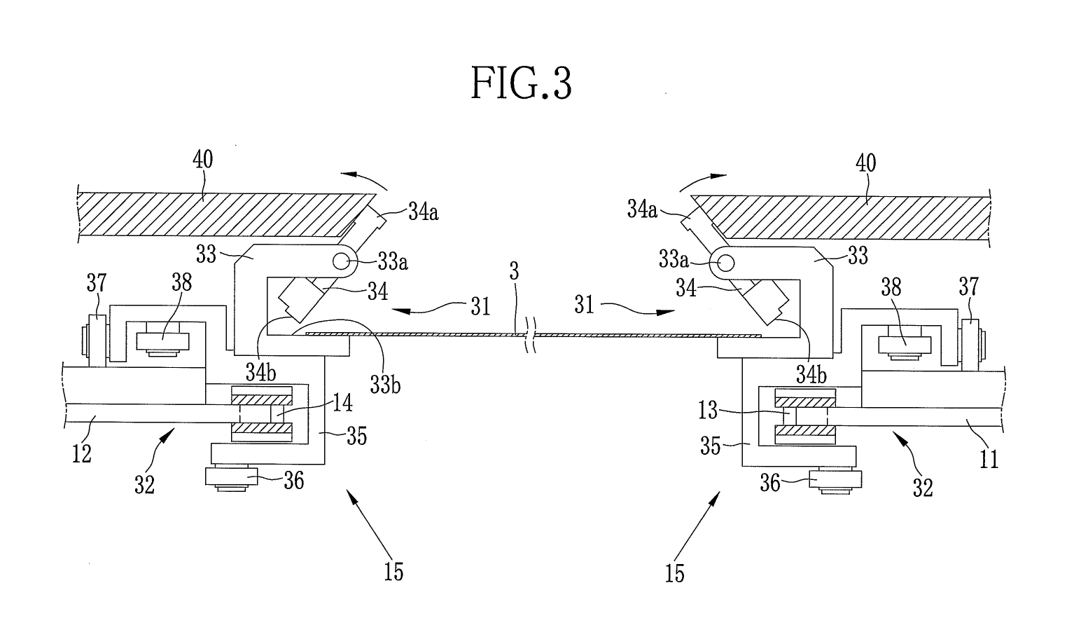

As shown in FIG. 3, each clip 15 is constituted of a clip body 31 and a rail attachment portion 32. The clip body 31 is constituted of a substantially C-shaped frame 33 and a flapper 34. The flapper 34 is rotatably attached to the frame 33 through an attachment shaft 33a. The flapper 34 moves between holding position and releasing position. In the holding position, the flapper 34 becomes vertical. In the releasing position, as shown in FIG. 3, a releasing member 40 contacts and pushes an engagement head 34a of the flapper 34, and thereby tilting the flapper 34 from the vertical position. That is, the flapper 34 swings around the attachment shaft 33a. The flapper 34 is normally in the holding position under its own weight. The TAC film 3 is held between a film holding surface 33b of the frame 33 and a flapper lower surface 34b of the flapper 34. The film holding initiates at a position (holding initiation point) PA (see FIG. 2).

The rail attachment portion 32 is constituted of an attachment frame 35 and guide rollers 36, 37 and 38. The first chain 13 or the second chain 14 is attached to the attachment frame 35. The guide rollers 36, 37 and 38 rotate by contacting with a support surface of the drive sprocket wheel 21 or 22, or a support surface of the first rail 11 or the second rail 12. Owing to this, the clip 15 is guided along the first rail 11 or the second rail 12 without dropping off of the drive sprocket wheel 21 or 22.

The releasing member 40 is arranged near the sprocket wheel 21, 22, 23 and 24 (see FIG. 2). The releasing members 40 near the driven sprocket wheels 23 and 24 contact and push the engagement heads 34a of the flappers 34 of the clips 15 at the position upstream from the position PA, and thereby putting the flappers 34 into the releasing position. Owing to this, the clips 15 can receive the side edges of the TAC film 3. At the time when the clips 15 pass the position PA, the releasing members 40 retract from the engagement heads 34a, and thereby putting the flappers 34 into the holding position. Owing to this, the clips 15 hold the side edges of the TAC film 3. In the same manner, the releasing members 40 near the drive sprocket wheels 21 and 22 put the flappers 34 into the releasing position at the time when the clips 15 pass a position (holding release point) PB. Owing to this, the clips 15 release the holding of the side edges of the TAC film 3.

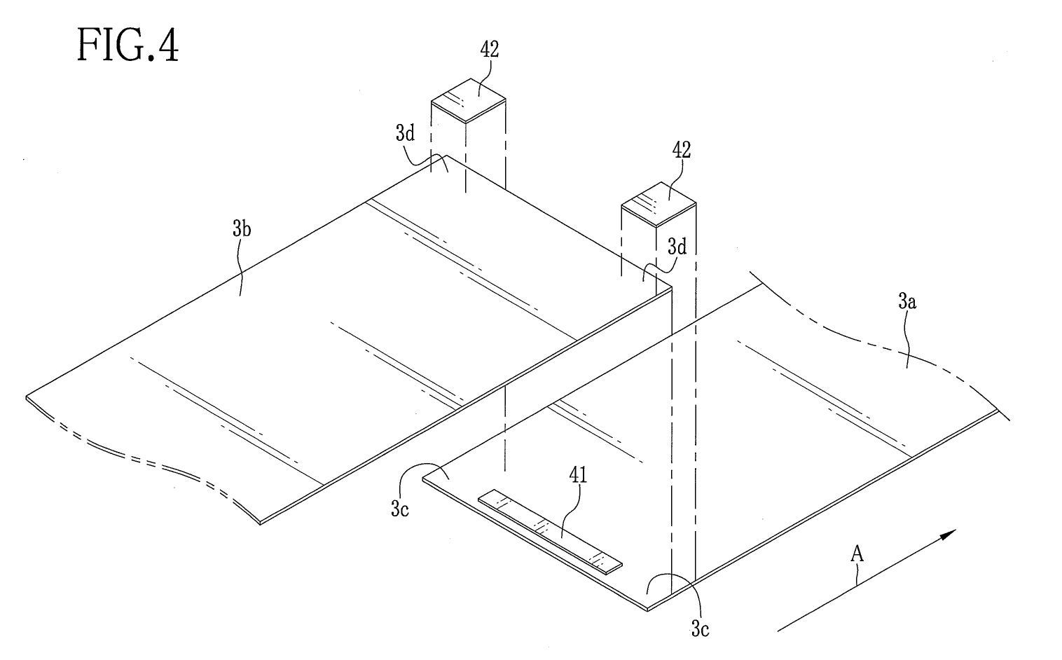

As shown in FIG. 4, the TAC films 3 are connected to continuously stretch them in the tenter 5. A rear end portion of the TAC film 3 (leading film 3a), which has been supplied from the supplying chamber 4, and a front end portion of the newly supplied TAC film 3 (following film 3b) are connected using a double-sided adhesive tape 41 and a single-sided adhesive tape 42. The double-sided adhesive tape 41 is used for connecting main parts of the TAC films 3 that are going to be a final product. The single-sided adhesive tape 42 is used for connecting the side edges of the TAC films 3 that are going to be slit in a later process. Base materials and adhesive materials for the adhesive tapes 41 and 42, and thickness thereof are not limited. For example, commercially available adhesive tapes having a polyester film base and an acrylic adhesive material may be used. The base materials for the adhesive tapes 41 and 42 are generally made of polyester and the like.

To connect the rear end portion of the leading film 3a and the front end portion of the following film 3b with the double-sided adhesive tape 41, first of all, the double-sided adhesive tape 41 is stuck on an upper surface of the rear end portion of the leading film 3a. Then, the front end portion of the following film 3b is placed on the rear end portion of the leading film 3a, and thereby connecting the films 3a and 3b with the double-sided adhesive tape 41. The films 3a and 3b are also connected with the single-sided adhesive tape 42. Side edges 3c of the rear end portion of the leading film 3a and side edges 3d of the front end portion of the following film 3b are connected with the single-sided adhesive tapes 42. The connection using the tapes 41 and 42 is performed upstream from the reservoir 10. At the time of the connection, the TAC film 3 that has been reserved in the reservoir 10 is sent to the tenter 5. Owing to this, the film connection can be performed without stopping the film conveyance. The film connection may be performed automatically by machine, or may be performed manually in the case where the off-line stretching device 2 has a simple configuration. When the film connection is performed by an automatic connecting device, the rear end portion and the front end portion to be connected are located at predetermined positions. Then, the double-sided adhesive tape 41 is supplied and stuck at a predetermined position. After that, the rear end portion and the front end portion are layered such that the double-sided adhesive tape 41 is interposed therebetween, and pressed to adhere each other. Next, the single-sided adhesive tapes 42 are supplied at predetermined positions and connect the leading and following films 3a and 3b.

After the stretching in the tenter 5, the TAC films 3 are sent to an edge slitting device 43 as shown in FIG. 1. In the edge slitting device 43, both side edges of the TAC films 3 are slit with cutters 44. The side edges are the parts of the TAC films 3 held with the clips 15. The slit side edges are sent to a cutter blower 45. The main parts of the TAC films 3 from which the side edges have been slit are sent to the stress relaxation chamber 6.

In the stress relaxation chamber 6, plural rollers 46 are provided. While being conveyed by the rollers 46, the TAC films 3 are heated and thereby relaxing the internal stress thereof. In the stress relaxation chamber 6, an air blower (not shown) sends air at a desired temperature. The temperature of the air is preferably in the range of 20° C. to 250° C. Then, the TAC films 3 are sent to the cooling chamber 7.

In the cooling chamber 7, the TAC films 3 are cooled until the temperature thereof reaches 30° C. or less, and then sent to the winding chamber 8. In the winding chamber 8, the TAC films 3 are wound by a winding roll 47. At the time of winding, a press roller 48 applies tension to the TAC films 3.

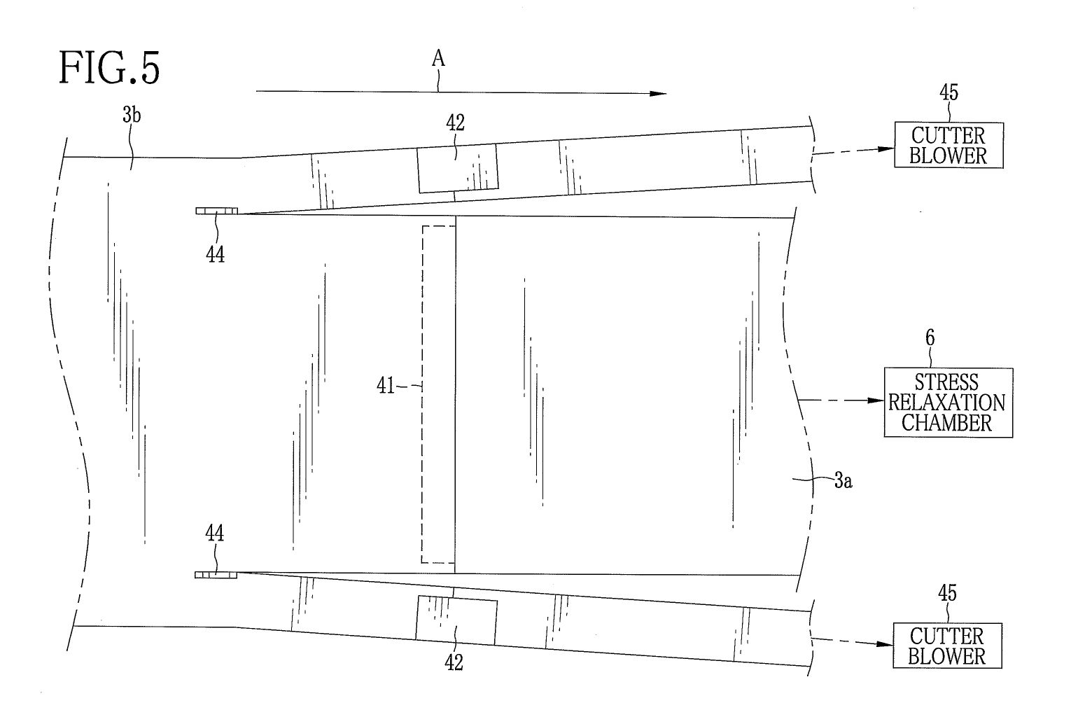

As shown in FIG. 5, a double-sided adhesive tape 41 is used for connecting the main parts of the TAC films 3. The main part of the TAC film 3 is a center part in the width direction of the TAC film 3 between the side edges. The single-sided adhesive tape 42 is used for connecting the side edges of the TAC films 3. Since the tapes 41 and 42 are not positioned on lines along which the side edges are slit with the cutters 44, the tapes 41 and 42 do not adhere to the cutters 44. Owing to this, contamination of the cutters 44 or deterioration in sharpness of cutting edges of the cutters 44 due to the adhesion of the tapes 41 and 42 can be prevented.

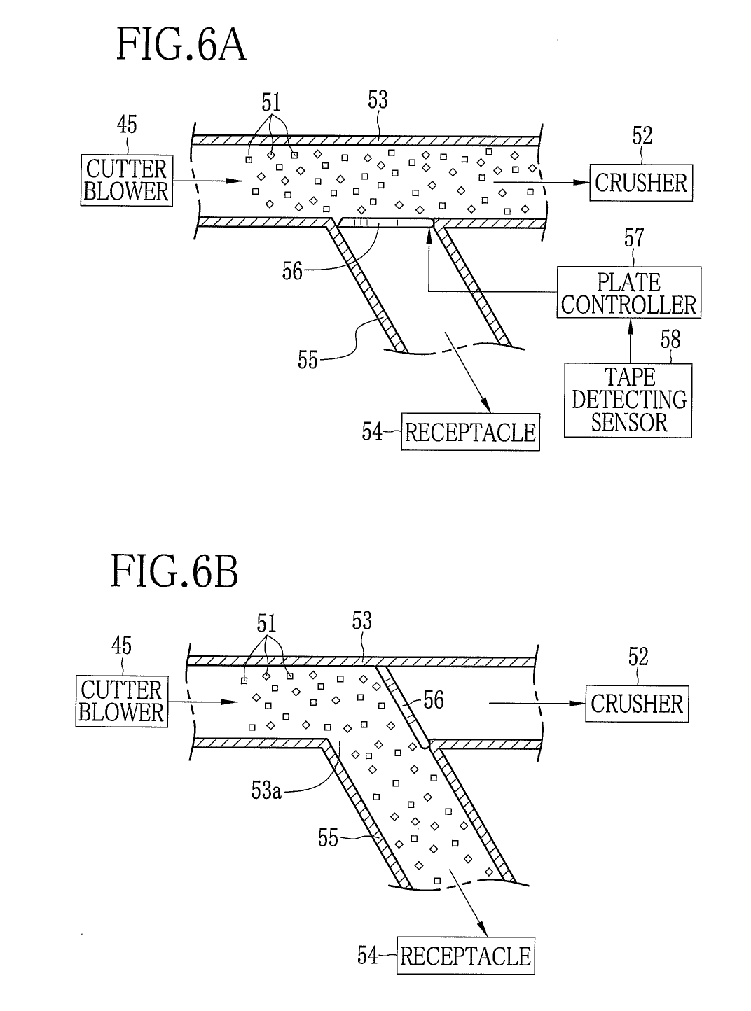

As shown in FIGS. 6A and 6B, the slit side edges of the TAC films 3 are cut into small pieces (hereinafter, cut films 51) in the cutter blower 45. The cut films 51 are sent to a crusher 52.

The cutter blower 45 and the crusher 52 are connected through a first pipe 53. The cut films 51 cut in the cutter blower 45 are sent to the crusher 52 through the first pipe 53. A blower (not shown) blowing air from the cutter blower 45 to the crusher 52 is provided inside the first pipe 53. The cut films 51 are blown by the air from the blower. To the first pipe 53, a second pipe 55 is connected via an opening 53a such that the second pipe 55 branches off from the first pipe 53. The cut films 51 having the single-sided adhesive tape 42 attached are sent to a receptacle 54 through the second pipe 55.

Inside the first pipe 53 is pivotally provided a plate 56. The plate 56 is rotatable between a close position (see FIG. 6A) and an open position (see FIG. 6B) by a plate controller 57 having motor, CPU and the like. When the plate 56 is in the close position, the plate 56 closes the opening 53a, and the cut films 51 are sent to the crusher 52 through the first pipe 53. When the plate 56 is in the open position, the plate 56 opens the opening 53a, and the cut films 51 are sent from the first pipe 53 to the second pipe 55 via the opening 53a and then sent to the receptacle 54. The plate 56 is normally set to the close position by the plate controller 57.

The edge slitting device 43 is provided with a tape detecting sensor 58 for detecting the single-sided adhesive tape 42. The tape detecting sensor 58 outputs a tape detection signal to the plate controller 57 when detecting the existence of the single-sided adhesive tape 42. Upon receiving the tape detection signal, the plate controller 57 rotates the plate 56 from the close position to the open position. When the plate 56 is rotated to the open position, the cut films 51 are sent to the receptacle 54 through the first pipe 53, the opening 53a, and the second pipe 55.

The plate 56 stays in the open position for a predetermined period of time. The predetermined period is determined to be longer than the time taken for the cut films 51 with the single-sided adhesive tape 42 passing the plate 56. After the expiration of the predetermined time period, the plate controller 57 rotates the plate 56 back to the close position. For this configuration, the cut films 51 with the single-sided adhesive tape 42 are not sent to the crusher 52 but sent to the receptacle 54. The cut films 51 with the single-sided adhesive tape 42 sent to the receptacle 54 cannot be recycled and therefore are discarded. The position of the tape detecting sensor 58 is appropriately changed as long as it is located upstream from the plate 56. In this embodiment, the separating member for separating the cut films 51 with the single-sided adhesive tape 42 from other cut films 51 is constituted of the plate 56 and the plate controller 57.

The cut films 51 sent to the crusher 52 are shredded into chips. Since the chips can be recycled for preparing the dope, this method is advantageous in view of the cost savings. In addition, the cut films 51 sent to the crusher 52 do not have the single-sided adhesive tape 42 attached, and therefore saving the trouble of removing the tape 42 at the time of recycling.

In this embodiment, a recovering device 59 shown in FIG. 1 is constituted of the edge slitting device 43, cutters 44, cutter blower 45, crusher 52, first pipe 53, receptacle 54, second pipe 55, plate 56, plate controller 57, and tape detecting sensor 58.

The TAC film 3 is produced according to the well-known solution casting method such as, for example, a method disclosed in Japanese Patent Laid-open Publication No. 2005-104148. To increase the film production speed, the dope including TAC and the solvent is cast on the cooled drum. The casting film is cooled and gelated to have the self-supporting properties. After having possessed the self-supporting properties, the casting film is peeled. The peeled film is dried in a pin tenter and then wound into a roll form as a TAC film. When the present invention is applied to such TAC film, the TAC film having excellent optical properties can be produced effectively and efficiently.

In this embodiment, the TAC film 3 is used as the example of the polymer film. However, the present invention can also be applied to other kinds of polymer films.

Various changes and modifications are possible in the present invention and may be understood to be within the present invention.

What is claimed is:

1. A method for stretching polymer films in width directions thereof comprising the steps of:
connecting a rear end of leading said polymer film and a front end of following said polymer film using a connection tape;
supplying the connected polymer films continuously;
stretching the supplied polymer films by holding both side edges thereof with clips, said polymer films being conveyed by said clips during said stretching step;
slitting said side edges from main parts of said polymer films after said stretching step, said main part being a center part in the width direction of said polymer film between said side edges, said main part becoming an end product;
cutting the slit side edges into small pieces by a cutter blower and blowing said small pieces by said cutter blower;
separating said small pieces with said connection tape from other small pieces based on information indicating position of said connection tape; and
recovering said small pieces with said connection tape and other small pieces separately.

2. The method according to claim 1, wherein said connection tape is positioned besides lines along which said side edges are slit.

3. A recovering device for recovering slit film edges provided to a film stretching device for connecting a rear end of a leading polymer film and a front end of a following polymer film using a connection tape, supplying the connected polymer films continuously, and stretching the supplied polymer films in width directions thereof by holding both side edges thereof with clips, said polymer films being conveyed by the clips during said stretching step, said recovering device comprising:
a slitting device for slitting said side edges from main parts of said polymer films after said stretching step, said main part being a center part in the width direction of said polymer film between said side edges, said main part becoming an end product;
a cutter blower for cutting the slit side edges into small pieces and blowing said small pieces;
a separating member provided downstream from said cutter blower, said separating member separating said small pieces with said connection tape from other small pieces based on information indicating position of said connection tape; and
a recovering section for recovering said small pieces with said connection tape and other small pieces separately.
